(19) United States
(12) Patent Application Publication
(10) Pub. No.: US 2023/0417873 A1
(43) Pub. Date: Dec. 28, 2023

(54) OBJECT RECOGNITION APPARATUS

(71) Applicants: SOKEN, INC., Nisshin-city (JP); DENSO CORPORATION, Kariya-city (JP)

(72) Inventors: Tetsuya KUSUMOTO, Nisshin-city (JP); Shingo SHIMIZU, Nisshin-city (JP); Takashi OGAWA, Kariya-city (JP); Masaki YONEDA, Kariya-city (JP)

(21) Appl. No.: 18/463,156

(22) Filed: Sep. 7, 2023

Related U.S. Application Data
(63) Continuation of application No. PCT/JP2022/004054, filed on Feb. 2, 2022.

(30) Foreign Application Priority Data
Mar. 9, 2021 (JP) 2021-037570

(51) Int. Cl. G01S 7/48; G01S 17/66; G01S 17/931

(52) U.S. Cl. CPC G01S 7/4802; G01S 17/66; G01S 17/931

(57) ABSTRACT

A positional information acquiring unit that acquires positional information in accordance with an object detection signal of the object sensor includes a first acquiring unit that acquires first observation information as positional information using a first threshold, and a second acquiring unit that acquires second observation information as positional information using a second threshold different from the first threshold. The object tracking unit is provided with a first tracking processing unit that executes a tracking process in accordance with the first observation information and a second tracking processing unit that executes the tracking process in accordance with the second observation information. Either one of the first tracking processing unit or the second tracking processing unit has anti-clutter characteristics higher than that of the other one. A state identifying unit identifies the state of the object based on a result of the tracking process executed by the tracking processing unit.

### CROSS-REFERENCE OF RELATED APPLICATIONS

This application is the U.S. bypass application of International Application No. PCT/JP2022/004054 filed on Feb. 2, 2022, which designated the U.S. and claims priority to Japanese Patent Application No. 2021-37570 filed on Mar. 9, 2021, the content of which is incorporated herein.

### BACKGROUND

### Technical Field

The present disclosure relates to an object recognition apparatus mounted on a vehicle, configured to recognize an object existing in the vicinity of the vehicle.

### Description of the Related Art

An apparatus for recognizing an object using a periphery monitoring sensor such as radar apparatus is known.

A detection signal detected by a periphery monitoring sensor such as a radar apparatus may contain noise referred to as clutter. The clutter noise is caused by an external disturbance or a thermal noise in the sensor. In this respect, a threshold for peak detection may be set in order to reliably detect the peak of a target object in the clutter. In view of improving anti-clutter characteristics, the threshold for eliminating the clutter noise may be set to be sufficiently high.

### SUMMARY

The present disclosure provides an on-vehicle object recognition apparatus capable of achieving both of a large recognition region and high anti-clutter characteristics.

An object recognition apparatus is mounted on a vehicle and configured to recognize an object existing in the vicinity of the vehicle.

According to one aspect of the present disclosure, the object recognition apparatus includes: a positional information acquiring unit configured to acquire, when a reception intensity peak of reflection waves contained in an object detection signal exceeds a threshold, positional information corresponding to the reception intensity peak, the object detection signal being generated by an object sensor mounted to the vehicle, the object sensor emitting probing waves as electromagnetic waves and receiving reflection waves of the probing waves which are reflected at the object; an object tracking unit that executes, based on the positional information acquired by the positional information acquiring unit, a tracking process of the object; and a state identifying unit that identifies a state of the object based on a result of the tracking process executed by the object tracking unit.

In the specification, reference symbols in parenthesis are sometimes applied to respective elements. However, even in this case, the reference symbols merely indicate an example of relationship between the respective elements and specific means described in the later-described embodiments. Hence, the present disclosure is not limited by the above-mentioned reference symbols.

### BRIEF DESCRIPTION OF THE DRAWINGS

FIG. 1 is a block diagram showing an overall configuration of an on-vehicle system;

FIG. 2 is a block diagram showing an overall functional configuration of an object recognition apparatus accomplished by a control unit shown in FIG. 1;

FIG. 3 is a block diagram showing an overall functional configuration of the object recognition apparatus shown in FIG. 2 according to a first embodiment;

FIG. 4 is a block diagram showing an overall functional configuration of the object recognition apparatus shown in FIG. 2 according to second embodiment to fifth embodiment;

FIG. 5 is a block diagram showing an overall functional configuration of the object recognition apparatus shown in FIG. 2 according to third embodiment to fifth embodiment;

FIG. 6 is a flowchart showing one operation example of the object recognition apparatus shown in FIG. 4 or FIG. 5 according to the fifth embodiment;

FIG. 7 is a block diagram showing an overall functional configuration of the object recognition apparatus shown in FIG. 2 according to a sixth embodiment;

FIG. 8 is a graph showing overall operation of the object recognition apparatus shown in FIG. 7;

FIG. 9 is a block diagram showing an overall functional configuration of the object recognition apparatus shown in FIG. 2 according to a seventh embodiment;

FIG. 10 is a graph showing overall operation of the object recognition apparatus shown in FIG. 9; and

FIG. 11 is a block diagram showing an overall functional configuration of the object recognition apparatus shown in FIG. 2 according to an eighth embodiment.

### DETAILED DESCRIPTION OF THE PREFERRED EMBODIMENTS

An apparatus for recognizing an object using a periphery monitoring sensor such as radar apparatus is known. For example, JP-A-1999-271431 discloses such an apparatus.

A detection signal detected by a periphery monitoring sensor such as a radar apparatus may contain noise referred to as clutter. The clutter noise is caused by an external disturbance or a thermal noise in the sensor. In this respect, according to the apparatus disclosed by the above patent literature JP-A-1999-271431, a threshold for peak detection is set in order to reliably detect the peak of a target object in the clutter. In view of improving anti-clutter characteristics, the threshold for eliminating the clutter noise may be set to be sufficiently high. However, a reception intensity of reflection waves reflected by an object existing away from the sensor may be too weak to differentiate the reflection waves from the clutter. Hence, when setting the threshold to be higher, object information in a far distance region may be lost. In particular, for an on-vehicle type object recognition apparatus, in order to enhance a driving assist level or an automatic driving level, it may be highly necessary to extend the size of a recognizable region. On the other hand, when setting the threshold to be lower, it is possible that an effect of eliminating clutter is not sufficient.

### Embodiments

Hereinafter, with reference to the drawings, embodiments of the present disclosure will be described. For various modification examples applicable to one embodiment, when inserting them in the middle of the series of explanations, understanding of the embodiments may be interfered with. Hence, the modification examples are placed after explanation of the embodiments.

### Configuration

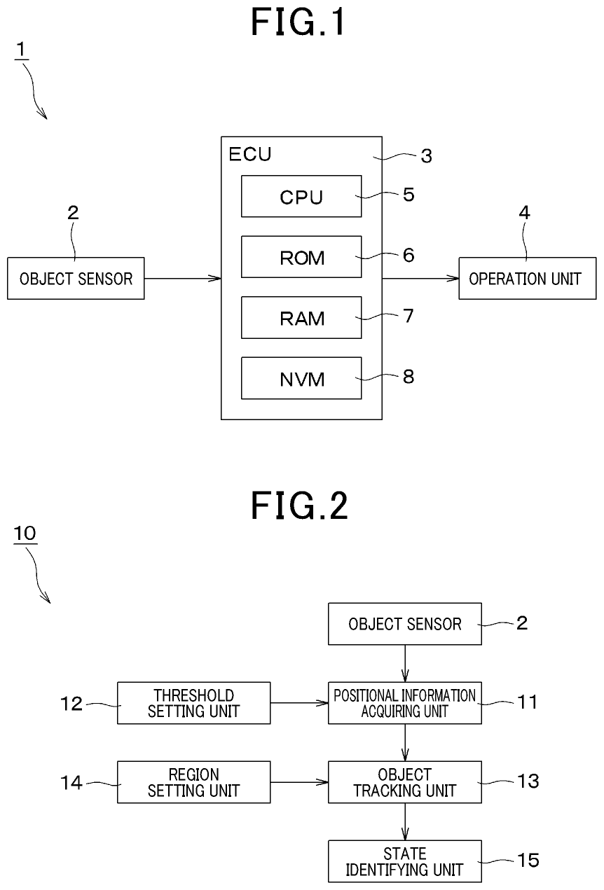

With reference to FIG. 1, an on-vehicle system 1 is configured to detect objects in the vicinity of an own vehicle and execute various operations (e.g. driving assist operations) depending on the detection result. The own vehicle refers to a vehicle on which the on-vehicle system 1 is mounted.

Specifically, the on-vehicle system 1 is provided with an object sensor 2, a control unit 3 and an operation unit 4. Hereinafter, respective parts that configure the on-vehicle system 1 will be described.

The object sensor 2 serves as a so-called surrounding monitoring sensor and is configured to emit probing waves as electromagnetic waves having a predetermined wavelength and receives reflection waves reflected at an object, thereby detecting the object within a predetermined detection region. The predetermined detection region refers to a region within a predetermined distance and a predetermined azimuth angle region with respect to the object sensor 2. According to the present embodiment, the object sensor 2 is configured as a so-called LIDAR sensor using laser light as the probing waves.

The object sensor 2 is configured to generate an object detection signal corresponding to the detection result of an object. Also, the object sensor 2 is communicably connected to the control unit 3 via an on-vehicle communication line such that the generated object detection signal is outputted to the control unit.

The control unit 3 is an electronic circuit unit referred to as an object recognition ECU or an object detection ECU. The control unit 3 is configured to recognize objects in the vicinity of the own vehicle based on the object detection signal acquired by the object sensor 2. The ECU is an abbreviation of electronic control unit. The control unit 3 is configured to output various operation command signals based on the recognition result of the object to the operation unit 4. The operation unit 4 is communicably connected to the control unit 3 via an on-vehicle communication line. The operation unit 4 is configured to execute various operations (e.g. driving assist operation) in the vehicle based on the operation command signal transmitted from the control unit 3.

The control unit 3 is configured as a so-called on-vehicle microcomputer provided with CPU 5, ROM 6, RAM 7 and non-volatile memory 8. The non-volatile memory 8 is a non-volatile rewritable memory such as a hard disk, EEPROM, flash ROM and the like. EEPROM is an abbreviation of electronically erasable and programmable ROM. The ROM 6 and the non-volatile memory 8 correspond to a computer readable non-transitory tangible recording media which stores programs.

The control unit 3 is configured such that the CPU 5 reads a program from the ROM 6 or the non-volatile memory 8 and executes the read program, whereby various control operations are executed. The program includes a later-described operations and processing commands corresponding to the flowchart. Also, the RAM 7 and/or the non-volatile memory 8 is configured to be capable of temporarily store the processing data when the CPU 5 executes the program. Further, the ROM 6 and/or the non-volatile memory 8 stores in advance various data used for executing the program. The various data includes, for example, initial values, lookup tables, maps and the like.

FIG. 2 shows an overall functional block diagram of an object recognition apparatus 10 according to one embodiment of the present disclosure, which is accomplished by executing the program by the control unit 3 shown in FIG. 1. That is, the object recognition apparatus 10 mounted on the own vehicle is configured to recognize the object existing around the own vehicle. Specifically, the object recognition apparatus 10 is provided with, as a functional configuration accomplished by the on-vehicle microcomputer, a positional information acquiring unit 11, a threshold setting unit 12, an object tracking unit 13, a region setting unit 14 and a state identifying unit 15.

The positional information acquiring unit 11 is configured to acquire, when a reception intensity peak of reflection waves contained in the object detection signal exceeds a threshold, the positional information corresponding to the reception intensity peak. The threshold setting unit 12 is configured to set the above-described threshold used in the positional information acquiring unit 11.

The object tracking unit 13 is configured to execute a tracking process of an object based on the positional information acquired by the positional information acquiring unit 11. Specifically, the object tracking unit 13 includes, as an algorithm of the tracking process of the object tracking unit 13, a state estimation filter that estimates a density distribution of an object, such as Kalman filter and a particle filter.

Note that, as the state estimation filter, in view of acquiring high anti-clutter characteristics, filters in accordance with random finite set theory (i.e. RFS theory) may preferably be utilized.

As the state estimation filter in accordance with the random finite set theory, PHD filter, CPHD filter, CBMeMBer filter, GLMB filter, LMB filter, PMB filter, PMBM filter and the like are known. PHD is an abbreviation of probability hypothesis density. CPHD is an abbreviation of cardinalized probability hypothesis density. CBMeMBer is an abbreviation of cardinality balanced multi-Bernoulli. GLMB is an abbreviation of generalized labeled multi-Bernoulli. LMB is an abbreviation of labeled multi-Bernoulli. PMB is an abbreviation of Poisson multi-Bernoulli. PMBM is an abbreviation of Poisson multi-Bernoulli Mixture. Hereinafter, the object tracking process using the state estimation filter in accordance with the random finite set theory is abbreviated as RFS tracking.

The region setting unit 14 is configured to set a tracking region which is an object region of the tracking process executed by the object tracking unit 13. The tracking region is any one of a spatial region, a time region and a signal.

The state identifying unit 15 is configured to identify the state of the object based on a result of the tracking process executed by the object tracking unit 13. An identification of a state of the object includes identification of a relative position and a relative speed of the object as a tracking object with respect to the own vehicle. The object recognition apparatus 10 according to the present disclosure is configured to be capable of changing the threshold and/or the tracking region by the threshold setting unit 12 and/or the region setting unit 14. The object recognition apparatus 10 is configured to recognize an object based on a result of a plurality of tracking processes having mutually different thresholds and/or tracking regions.

### First Embodiment: Configuration

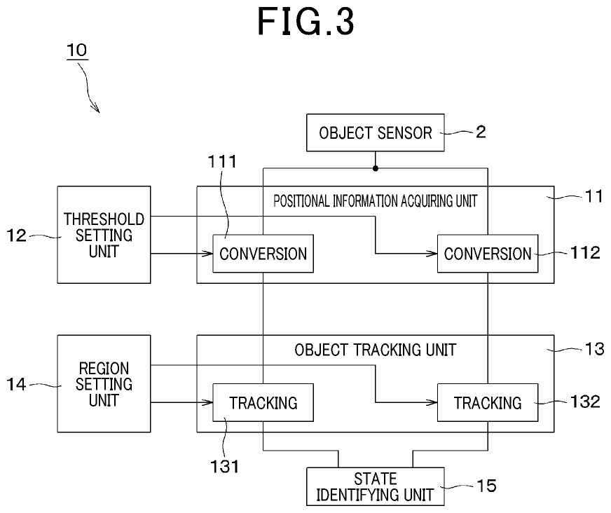

Hereinafter, with reference to FIG. 3, a configuration of the object recognition apparatus 10 according to the first embodiment will be described. According to the present embodiment, the positional information acquiring unit 11 includes a first acquiring unit 111 and a second acquiring unit 112. Also, the object tracking unit 13 includes a first tracking processing unit 131 and a second tracking processing unit 132.

The first acquiring unit 111 is configured to acquire, when a reception intensity peak exceeds a first threshold THA, a first observation information which is positional information corresponding to the reception intensity peak. That is, the first acquiring unit 111 converts the reception signal which is a time-changing waveform of the reception intensity to be the first observation information as point group information, using the first threshold THA set by the threshold setting unit 12.

The second acquiring unit 112 is configured to acquire, when a reception intensity peak exceeds a second threshold THA different from the first threshold THA, second observation information which is positional information corresponding to the reception intensity peak. That is, the second acquiring unit 112 converts the reception signal to be second observation information as point group information, using the second threshold THB set by the threshold setting unit 12. Also, according to the present embodiment, the threshold setting unit 12 sets the second threshold THB to be higher than the first threshold THA. That is, first threshold THA<second threshold THB.

The first tracking processing unit 131 is configured to execute a tracking process based on the first observation information which is the point group information acquired by the first acquiring unit 111. Similarly, the second tracking processing unit 132 is configured to execute a tracking process based on the second observation information which is the point group information acquired by the second acquiring unit 112. The state identifying unit 15 is configured to identify the state of the object based on a result of the tracking process executed by the first tracking processing unit 131 and the second tracking processing unit 132.

According to the present embodiment, the first tracking processing unit 131 and the second tracking processing unit 132 are configured such that either one unit between the first tracking processing unit 131 and the second tracking processing unit 132 has higher anti-clutter characteristics than that of the other unit. Specifically, the first tracking processing unit 131 that executes the tracking process based on the first observation information acquired using the first threshold THA having relatively lower threshold value, has higher anti-clutter characteristics than that of the second tracking processing unit 132. As a suitable example, at least first tracking processing unit 131 is configured to execute a RFS tracking.

According to the present embodiment, the region setting unit 14 sets a spatial region as mutually different tracking region in the first tracking processing unit 131 and the second tracking processing unit 132. That is, the first tracking processing unit 131 executes a tracking process based on a first observation information that satisfies a condition in which the positional information indicates that it is in the first region. The second tracking processing unit 132 executes a tracking process based on a second observation information that satisfies a condition in which the positional information indicates that it is in the second region.

Here, the second region refers to a spatial region including nearer distance region than the first region. Specifically, for example, assuming that a distance to the object sensor 2 is X [unit: meter], the first region is set to be a far distance region, i.e. X=100 to 120, and the second region is set to be a near distance region, i.e. X=0 to 100.

### First Embodiment: Operation

Hereinafter, with reference to FIGS. 1 to 3, an overall operation of the object recognition apparatus 10 according to the present embodiment and an object recognition method and an object recognition program executed by the object recognition apparatus will be described together with effects and advantages obtained therefrom. In the following description, a configuration of the object recognition apparatus 10 according to the present embodiment, process of the object recognition method and the object recognition program executed by the object recognition apparatus 10 may be referred to as present embodiment.

The object recognition apparatus 10 repeatedly executes an object recognition process at every predetermined processing cycles. At one cycle of the object recognition process, firstly, the object recognition apparatus 10 acquires (i.e. receives), from the object sensor, an object detection signal corresponding to the detection result of the object detected by the object sensor 2. Next, the object recognition apparatus recognizes objects existing in the vicinity of the own vehicle based on the acquired object detection signal.

Specifically, in the positional information acquiring unit 11, the first acquiring unit 111 acquires, based on the first threshold THA set by the threshold setting unit 12, a first observation information as the positional information. Further, in the object tracking unit 13, the first tracking processing unit 131 executes the tracking process based on the first observation information acquired by the first acquiring unit 111 and the first region set by the region setting unit 14.

On the other hand, in the positional information acquiring unit 11, the second acquiring unit 112 acquires the second observation information based on the object detection signal and the second threshold THB set by the threshold setting unit 12. Further, in the object tracking unit 13, the second tracking processing unit 132 executes the tracking process based on the second observation information acquired by the second acquiring unit 112 and the second region set by the region setting unit 14.

The state identifying unit 15 integrates the result of the tracking process executed by the first tracking processing unit 131 and the result of the tracking process executed by the second tracking processing unit 132, thereby identifying the state of objects in the vicinity of the own vehicle. Thus, the state identifying unit 15 recognizes objects existing in the vicinity of the own vehicle. Then, the object recognition apparatus 10 outputs, based on the recognition result of the object, an operation command signal to cause the operation unit 4 to execute various operations (e.g. driving assist operation) related to a driving of the own vehicle.

The object detection signal detected by the object sensor 2 which is LIDAR sensor possibly contains clutter caused by external disturbance or thermal noise. In this respect, when generating the observation information as a positional information used for the tracking process of the object tracking unit 13, a threshold is used for eliminating the clutter.

In this respect, the reception intensity of actual reflection waves reflected at an object is relatively high in a near distance region. Hence, in the near distance region, the threshold for eliminating the clutter is set to be sufficiently high, whereby the clutter is completely eliminated. In contrast, the reception intensity of actual reflection waves reflected at an object is weak in a far distance region, causing difficulty in differentiate as signal from the clutter. Hence, when setting the threshold to be high, the object information may be lost. On the other hand, when setting the threshold to be lower, clutter removal is insufficient and much of clutter may be used in calculation of the object tracking processing.

Here, it is considered that the tracking process of the object tracking unit 13 may be executed with RFS tracking. However, according to RFS tracking, the anti-clutter characteristics are high, but the processing load is high. Hence, in the case where the threshold is set to be sufficiently low or all of the reception signals are processed without using the threshold so as to prevent the object information from being lost, excessive calculation load may occur.

In particular, for an on-vehicle object recognition apparatus 10, in view of improving the driving assist level or the automatic driving level, a recognizable region, that is, a detection region of the object sensor 2 is highly required to be larger (longer distance region). Further, this type of the object recognition apparatus 10 is different from a stationary type apparatus (fixed-point observation type) which is fixed to a predetermined position. Hence, in a wide area from a near distance region to a far distance region, many objects move relative to the object sensor and the objects often enters and leaves a recognizable region. Accordingly, considering the processing load, applying RFS tracking method to this type of on-vehicle apparatus is not realistic.

For this reason, according to the present embodiment, the first acquiring unit 111 uses the first threshold THA having relatively low value to acquire the first observation information as the positional information. Also, the first tracking processing unit 131 executes the tracking process of an object in a far distance region based on the first observation information as a low threshold information acquired by the first acquiring unit 111 using a tracking method having high anti-clutter characteristics (e.g. RFS tracking).

On the other hand, the second acquiring unit 112 uses the second threshold THB having relatively high value to acquire the second observation information as the positional information. Further, the second tracking processing unit 132 executes the tracking process of an object in a near distance region based on the second observation information as the positional information using a conventional tracking process having low processing load (e.g. extended Kalman filter). Then, the state identifying unit 15 integrates the result of the tracking process in a far distance region executed by the first tracking processing unit 131 and the result of the tracking process in a near distance region executed by the second tracking processing unit 132, thereby identifying the state of objects.

Thus, the present embodiment is embodied focusing the following three facts.
(1) objects required to be recognized in a weak signal environment are limited to be in a far distance region where the signal level is low.
(2) an amount of processing (i.e. processing load) in the tracking process depends on the number of point groups to be processed such that the higher the threshold value, the lower the number of point groups is.
(3) when a tracking method including the RFS tracking method, having high anti-clutter characteristics, is used, the processing load becomes high while erroneous recognition can be reduced as much as possible.

According to the present embodiment, for a near distance region in which the signal intensity is relatively high, the threshold is set to be sufficiently high and an object is rapidly tracked using a conventional tracking method that requires relatively low processing load. On the other hand, according to the present embodiment, for a far distance region in which the signal intensity is relatively low, the threshold is set to be low and an object is tracked using a tracking method having high anti-tracking characteristics.

Thus, the object recognition for a wide region from a near distance region to a far distance region can preferably be accomplished avoiding erroneous recognitions due to clutter and without excessively increasing the processing load. That is, according to the present embodiment, an on-vehicle object recognition apparatus 10 capable of achieving a long distance recognition region and high anti-clutter characteristics can be obtained.

In the above-described preferred examples, the first tracking processing unit 131 executes a tracking process for the first region based on the random finite set theory in which anti-clutter characteristics are high and the processing load is high. On the other hand, the second tracking processing unit 132 executes the tracking processing for the second region using a tracking method capable of performing high speed processing with a low processing load. Thus, both of the high speed processing and a far distance recognition can be accomplished.

As described, RFS tracking having high anti-clutter characteristics and high processing load is exclusively used, thereby favorably suppressing erroneous recognitions caused by clutter while suppressing an increase in the processing load. Further, according to the RFS tracking, generation of new objects and calculation of vanishing of existing objects can be probabilistically performed. The generation of new object and vanishment of existing objects mainly occur in the far distance region. Hence, RFS tracking is applied while lowering the threshold value in the far distance region, whereby object tracking can be executed in the far distance region with favorable accuracy, considering a probability of new objects newly entering the recognizable region and the existing object exiting from the recognizable region. On the other hand, objects existing in the near distance region have a high probability of collision with the own vehicle compared to objects existing in the far distance region. Therefore, a conventional method is applied while setting the threshold value to be higher in the near distance region, whereby erroneous recognition caused by clutter can be suppressed and the processing speed of the tracking process of the objects existing in the near distance region can be higher.

Hereinafter, effects of reducing the processing load according to the present embodiment will be further described using hypothetical cases. In the hypothetical cases, it is assumed that the number of point groups using the first threshold THA is 200 times larger than the number of point groups using the second threshold THB. Further, the first tracking processing unit 131 utilizes RFS tracking as the tracking method, and the second tracking processing unit 132 utilizes a conventional method such as an extended Kalman filter (i.e. non-RFS tracking) as the tracking method. Here, for the first tracking processing unit 131 and the second tracking processing unit 132, it is assumed that the number of point groups and the processing load have a proportional relationship. Further, in the case where the same point group is utilized, it is assumed that the processing time of the first tracking processing unit 131 is twice as that of the second tracking processing unit 132.

According to an example, the first tracking processing unit 131 tracks a far distance region, that is, the first region (X=100 m to 120 m) and the second tracking processing unit 132 tracks a near distance region, that is, the second region (X=0 m to 100 m). In contrast, according to the comparative example, the first tracking processing unit 131 tracks the entire recognizable region, that is, whole special region (X=0 m to 120 m).

It Is assumed that a required period of the tracking process according to the comparative example is 144 msec. At this moment, since the first region is 44/144 times the whole spatial region (i.e. whole recognizable region), the required period of the tracking process executed by the first tracking processing unit 131 for the first region is: 144×44/144=44 msec. The second region is 100/144 times the whole spatial region. The number of processing point groups by the second tracking processing unit 132 is 1/100 times the number of processing point groups of the first tracking processing unit 131. Further, in the case of the same number of processing point groups, the processing time of the second tracking processing unit 132 is ½ of the processing time of the first tracking processing unit 131. Hence, the required period of the tracking process executed by the second tracking processing unit 132 for the second region is: 144×(100/144)×(1/100)×(1/2)=0.5 msec. Therefore, the total processing period is 44.5 msec and the processing period is reduced to 70%.

### First Embodiment: Modification Examples

Hereinafter, modification examples capable of being applied to the first embodiment will be exemplified. The modification examples may be applied to other embodiments which follows the later-described second embodiment as long as no technical inconsistency is present.

The function for setting the threshold may be included in the positional information acquiring unit 11. Specifically, the positional information acquiring unit 11 (i.e. first acquiring unit 111 and second acquiring unit 112) may have a threshold set in advance. Hence, in FIGS. 2 and 3, the threshold setting unit 12 may be omitted.

Similarly, a function for setting the tracking region may be included in the object tracking unit 13. Specifically, in the object tracking unit 13 (i.e. first tracking processing unit 131 and second tracking processing unit 132, the tracking region may be set in advance. Hence, the region setting unit 14 can be omitted.

In FIG. 3, in view of using mutually different thresholds, that is, the first threshold THA and the second threshold THB, the first acquiring unit 111 and the second acquiring unit 112 are illustrated in a state where they are arranged in parallel. However, the present disclosure is not limited to this configuration. That is, as shown in FIG. 2, the threshold may be changed in a single positional information acquiring unit 11, thereby achieving a functional configuration corresponding the one shown in FIG. 3

Note that three or more tracking regions may be set. In this case, three or more thresholds may be set. Further, two or more tracking regions (e.g. first region and second region according to the above-described specific example) may be mutually and partially overlapped.

The tracking region may be time region. Specifically, for example, when performing an object detection for whole spatial region (i.e. whole recognizable region) for consecutive two times, the first time detection may be defined as the first region and the second time may be defined as the second region. In this case, the first tracking processing unit 131 executes the tracking process based on the positional information acquired by the positional information acquiring unit 11 in the first object detection. On the other hand, the second tracking processing unit 132 executes the tracking process based on the positional information acquiring unit 11 in the second object detection.

The tracking region may be a signal level region, that is, the reception intensity region. Specifically, for example, the object detection signal is assigned to a plurality of signal level regions, and the object tracking process may be performed for respective signal level regions.

The tracking region may be a combination of any two items among the spatial region, the time region and the signal level region. Specifically, for example, a total of four tracking regions may be set including a low signal level in the far distance region, a high signal level in the far distance region, a low signal level in the near distance region and a high signal level in the near distance region.

As described, the RFS tracking method is utilized, thereby improving the anti-clutter characteristics. In this respect, the number of processing point groups in the second tracking processing unit 132 is reduced by a predetermined degree due to high threshold setting. Hence, even when RFS tracking is applied to the second tracking processing unit 132, the processing load is unlikely to be excessively high. For this reason, RFS tracking can be applied to the second tracking processing unit 132 in addition to the first tracking processing unit 131. That is, the first tracking processing unit 131 and the second tracking processing unit 132 execute tracking process based on the random finite set theory. Thus, erroneous recognitions due to clutter noise may further preferably be suppressed.

### Second Embodiment

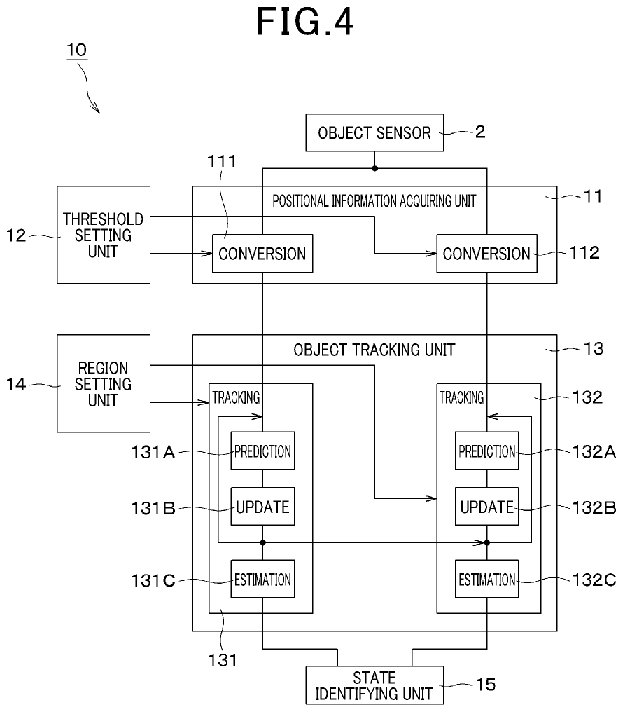

Hereinafter, with reference to FIG. 4, a configuration and operation of an object recognition apparatus 10 according to the second embodiment will be described. In the following description of the second embodiment, configurations different from that of the first embodiment will mainly be described. The same reference numbers are applied to portions having mutually the same or equivalent configuration between the first embodiment and the second embodiment. Accordingly, in the following description of the second embodiment, for constituents having the same reference numbers as those in the first embodiment, explanation of the first embodiment will be appropriately applied as long as no technical inconsistency is present or no specific additional explanation is required. The same applies to other embodiments of the later-described third embodiment and latter embodiments.

Also, in this embodiment, similar to the above-described first embodiment, the relationship between the first threshold and the second threshold is first threshold THA<second threshold THB, the first region is a far distance region (i.e. X=100-120) and the second region is a near distance region (i.e. X=0 to 100). Further, the first tracking processing unit 131 has higher anti-clutter characteristics that that of the second tracking processing unit 132. Similar to the above-described first embodiment, the first tracking processing unit 131 and the second tracking processing unit 132 may use non-RFS tracking. However, RFS tracking may preferably be applied to at least the first tracking processing unit 131. Further, RFS tracking may be applied to the second tracking processing unit 132.

According to the present embodiment, the second tracking processing unit 132 is configured to execute the tracking process based on a result of the tracking process executed by the first tracking processing unit 131. The object tracking unit 13 applies the result of the tracking process executed by the first tracking processing unit 131 to the second tracking processing unit 132, thereby smoothing the tracking processing result.

The first tracking processing unit 131 and the second tracking processing unit 132 are configured to successively repeat a prediction process and an updating process with a known state estimation filter, thereby estimating a state of the object at each time. Specifically, the first tracking processing unit 131 is provided with a first predicting unit 131A, a first updating unit 131B and a first estimation unit 131C. Similarly, the second tracking processing unit 132 is provided with a second predicting unit 132A and a second updating unit 132B and a second estimation unit 132C.

The first prediction unit 131A serves as a functional block corresponding to a prediction process or a prediction step in a tracking process algorithm using the state estimation filter. The first updating unit 131B serves as a functional block corresponding to an updating process or an updating step in the above-described algorithm.

Specifically, the first prediction unit 131A is configured to calculate, based on an update value of the state quantity at a previous processing time k−1, that is, the output value of the first updating unit 131B, a prediction value of a state quantity at a current processing time k. The first updating unit 131B updates (i.e. corrects) the prediction value calculated by the first prediction unit 131A, based on the first observation information acquired from the object detection signal at the current processing time k, thereby calculating the update value of the state quantity at the current processing time k. The first estimation unit 131C is configured to estimate an object state at the current processing time k, based on the updating value of the state quantity at the current processing time k, that is, the output value of the first updating unit 131B.

The second predicting unit 132A serves as a functional block corresponding to a prediction process or a prediction step in a tracking process algorithm using the state estimation filter. The second updating unit 132B serves as a functional block corresponding to an updating process or an updating step in the above-described algorithm.

The second prediction unit 132A is configured to calculate, based on an update value of the state quantity at a previous processing time k−1, that is, the output value of the second updating unit 132B, and the output value of the first updating unit 131B at the same time k−1, a prediction value of a state quantity at a current processing time k. In other words, the second prediction unit 132A is configured to obtain the output value of the first updating unit 131B and the second updating unit 132B at the previous processing time k−1 and output a prediction value of the state quantity at the current processing time k.

The second updating unit 132B updates (i.e. corrects) the prediction value calculated by the second prediction unit 132A, based on the second observation information acquired from the object detection signal at the current processing time k, thereby calculating the update value of the state quantity at the current processing time k. The second estimation unit 132C is configured to estimate the object state at the current processing time k, based on the update value of the state quantity at the current processing time k, that is, the output value of the second updating unit 132B.

Hereinafter, an overall operation of an object recognition apparatus according to the present embodiment, an overview of an object recognition method executed by the object recognition apparatus and an object recognition program will be described together with effects and advantages obtained therefrom will be described with reference to the drawing.

It is assumed that a target object which has been tracked by the first tracking processing unit 131 is estimated, at the current processing time k, to be in the second region of which the distance is less than 100 meters after completing the updating step at the previous processing time k−1. This means that a target object moved from the first region of which the distance is larger than or equal to 100 meters to the second region of which the distance is less than 100 meters. In this case, the object information is removed from the object information which has been tracked by the first tracking processing unit 131 and added to the object information which has been tracked by the second tracking processing unit 132.

Thus, the second tracking processing unit 132 immediately continues to track the focused object and takes over the ID information. That is, according to the present embodiment, it is possible to avoid a discontinuity at a boundary portion between the tracking region of the first tracking processing unit 131 and the tracking region of the second tracking processing region.

The configuration shown in FIG. 4 allows the object information after being updated in the first tracking processing unit 131 (i.e. output of the first updating unit 131B) to be transmitted to the second tracking processing unit 132. In contrast, the above configuration can be changed to a configuration in which the object information after being estimated in the first tracking processing unit 131 is transmitted to the second tracking processing unit 132.

### Third Embodiment

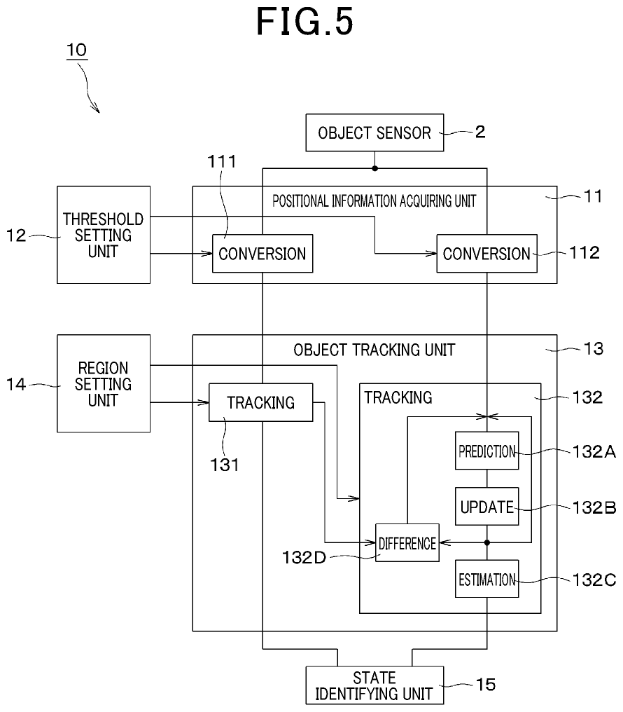

Hereinafter, with reference to FIG. 5, a configuration and an operation of an object recognition apparatus 10 according to the third embodiment will be described. The third embodiment is an embodiment in which a part of the second embodiment is modified. In other words, similar to the second embodiment, the second tracking processing unit 132 is configured to execute the tracking process based on the result of the tracking process executed by the first tracking processing unit 131.

According to the present embodiment, the first region which is a tracking region of the first tracking processing unit 131 and the second region which is a tracking region of the second tracking processing unit 132 are partially overlapped with each other. Specifically, for example, the first region is a far distance region (i.e. X=100 to 120) and the second region is the entire spatial region (i.e. X=0 to 120).

In this case, it is possible that the first tracking processing unit 131 and the second tracking processing unit 132 track the same object. Hence, it is required to compare the updating result or the estimation result of the first tracking processing unit 131 and the updating result of the second tracking processing unit 132, and the object information not corresponding to the same object is required to be transmitted to the second tracking processing unit 132.

In this respect, according to the present embodiment, the second tracking processing unit 132 is provided with a difference extracting unit 132D. The difference extracting unit 132D is configured to a difference between the result of the tracking process of the first tracking processing unit 131 and the result of the tracking process of the second tracking processing unit 132. Further, the second tracking processing unit 132 is configured to execute the tracking process based on the difference extracted by the difference extracting unit 132D. According to this configuration, even in a case where the first region which is the tracking region of the first tracking processing unit 131 and the second region which is the tracking region of the second tracking processing unit 132 are partially overlapped with each other, favorable object tracking process can be accomplished.

### Fourth Embodiment

Hereinafter, with reference to FIG. 4 or and FIG. 5, a configuration and an operation of an object recognition apparatus 10 according to the fourth embodiment will be described. The fourth embodiment is an embodiment in which the above-described second embodiment or the third embodiment is partly modified. Specifically, similar to the above-described second embodiment and the third embodiment, the second tracking processing unit 132 is configured to execute the tracking process based on the result of the first tracking processing unit 131.

According to the present embodiment, at least the second tracking processing unit 132 utilized the RFS tracking method. Also, a relationship: first threshold THA<second threshold THB is present, and the spatial region of the first region and the spatial region of the second region are the same.

In this case, the tracking region of the first tracking processing unit 131 corresponds to point group acquired when the first threshold THA is applied to the whole spatial region. Also, the tracking of the second tracking processing region 132 corresponds to point group acquired when the second threshold THB is applied to the whole spatial region. That is, the present example corresponds to an example in which the signal level region is different between the first region and the second region.

In RFS tracking, a spatial distribution where a new object is present is required to be predicted. In this respect, like the present disclosure, according to a configuration for monitoring an external environment of the own vehicle with the object sensor 2, since the external environment momentarily changes, predicting the spatial distribution of the new object is usually difficult.

For this reason, according to the present embodiment, the first tracking processing unit 131 performs a tracking in advance based on the point group using the first threshold THA which is a relatively low threshold, and this tracking result is utilized as a spatial distribution of the new object in the second tracking processing unit. Thus, recognition can be started early. Further, since the processing load of the second tracking processing unit 132 is not excessively high, the above-described configuration is effective in consideration of the processing load compared to a case where all of the threshold is set to be lowered.

In the case where the tracking region of the first tracking processing unit 131 is a point group larger than or equal to the first threshold THA and less than the second threshold THB, and the tracking region of the second tracking processing unit 132 is a point group larger than or equal to the second threshold THB, both tracking regions have no duplication. Hence, as shown in FIG. 4, the result of the tracking processing unit 131 can be directly transmitted to the second tracking processing unit 132. In other words, the difference extracting unit 132D shown in FIG. 5 can be omitted.

In contrast, the tracking region of the first tracking processing unit 131 is a point group larger than or equal to the first threshold THA, and the tracking region of the second tracking processing unit 132 is a point group larger than or equal to the second threshold, and so partial duplication occurs in both tracking regions. Hence, in this case, as shown in FIG. 5, the difference extracting unit 132D needs to be provided to acquire a difference between the tracking processing unit of the first tracking processing unit 131 and the updating result of the second tracking processing unit 132, which should be a predicted distribution of the new object.

According to the present embodiment, the first tracking processing unit 131 executes the tracking process based on the first observation information as the low threshold information. Also, the spatial range is the same between the first region as the object region of the tracking process of the first tracking processing unit 131 and the second region as the object region of the tracking process of the second tracking processing unit 132. Hence, for the first tracking processing unit 131, an object tracking processing algorithm having lower processing load than that of the second tacking processing unit 132 may preferably be utilized. The first tracking processing unit 131 executes a tracking process capable of executing high-speed processing, while the second tracking processing unit 132 executes more robust tracking process, whereby both a high speed processing and a far distance recognition characteristics can be accomplished.

As described above, according to the present embodiment, setting of the first threshold THA in the first acquiring unit 111 corresponds to setting of the tracking region of the first tracking processing unit 131. Similarly, setting of the second threshold THB of the second acquiring unit 112 corresponds to the tracking region of the second tracking processing unit 132. Hence, the region setting unit 14 can be omitted.

### Fifth Embodiment

Hereinafter, with reference to FIGS. 4 and 5, a configuration and operation of the object recognition apparatus 10 according to the fifth embodiment will be described. According to the present embodiment, the above-described fourth embodiment is partially modified. In other words, the second tracking processing unit 132 is configured to execute the tracking process based on a result of the tracking process of the first tracking processing unit 131. Further, the relationship between first and second thresholds is: first threshold THA<second threshold THB and the spatial region is the same between the first region and the second region.

According to the present embodiment, both of the first tracking processing unit 131 and the second tracking processing unit 132 utilize the RFS tracking method as a tracking method. Specifically, the first tracking processing unit 131 and the second tracking processing unit 132 are configured using a state estimation filter based on the random finite set theory.

The state estimation filter based on the random finite set theory can be divided into a first type filter that propagates Poisson intensity distribution and a second type filter that expresses the distribution with Bernoulli component. The PHD filter and the CPHD filter are categorized to the first type. CBMeMBer filer, GLMB filter, LMB filter, PMB filter and PMBM filter are categorized to the second type. Among these filters, the PMB filter and the PMBM filter differ from other filters in that the state distribution of existing objects is expressed by Bernoulli component and the state distribution of new objects are expressed by Poisson intensity distribution.

In this respect, according to the configuration shown in FIGS. 4 and 5 in which the result of the tracking process in the first tracking processing unit 131 is propagated to the second tracking processing unit 132, the performance thereof is influenced depending on which state estimate filter is utilized for respective first tacking processing unit 131 and the second tracking processing unit 132. That is, in the case where the state distribution propagated to the second tracking processing unit 132 from the first tracking processing unit 131 and the state distribution of the new object in the second tracking processing unit 132 are the same type, a conversion process between Poisson intensity distribution and Bernoulli component is unnecessary.

For this reason, according to the present embodiment, the object tracking unit 13 is configured such that a type of the state distribution included in the result of the tracking process outputted to the second tracking processing unit 132 from the first tracking processing unit 131 and the type of the state distribution of undetected object predicted by the second tracking processing unit 132 are the same. Thus, the processing load is reduced and the information loss due to an approximation during the conversion process can be avoided. Further, as described above, for the first tracking processing unit 131, an object tracking processing algorithm having lower processing load than that of the second tacking processing unit 132 may preferably be utilized. Thus, both of high speed processing and far distance recognition can be accomplished.

Considering the above aspects, preferable combinations between the first tracking processing unit 131 and the second tracking processing unit 132 are exemplified as follows. Note that the combinations are not limited to the following examples.

| First tracking | Second tracking |
|---|---|
| processing unit 131 | processing unit 132 |
| PHD | CPHD |
| PHD | PMBM |
| CPHD | PMBM |
| CBM | GLMB |
| CBM | LMB |
| LMB | GLMB |

Hereinafter, detailed operation examples of a configuration according to the present embodiment will be described. In the examples, the first tracking processing unit 131 is configured using a PHD filter or a CPHD filter as a state estimation filter that allows the Poisson intensity distribution to propagate. The state estimation filter used for the first tracking processing unit 131 corresponds to first filter according to the present disclosure. The second tracking processing unit 132 is configured using a PMBM filter as a state estimation filter that treats Poisson intensity distribution to be a state distribution of undetected object. The state estimation filter used for the second tracking processing unit 132 corresponds to second filter in the present disclosure.

Further, the first region is larger than or equal to the first threshold THA and less the second threshold THB, and the second region is larger than or equal to the second threshold THB. In this case, the functional block configuration corresponds to the one shown in FIG. 4.

The second tracking processing unit 132 as the PMBM filter is able to estimate the state distribution of undetected object in addition to the state distribution of the detected object. The state distribution of the detected object is expressed by Bernoulli component. On the other hand, the state distribution of the undetected object is expressed by Poisson intensity distribution. The undetected object expressed by the Poisson intensity distribution is used at the next processing time for a state distribution of an existing and undetected object (i.e. already being hidden in the tracking region but not yet detected).

On the other hand, according to the first tracking processing unit 131 as the PHD filter or the CPHD filter, a state distribution of a new and undetected object (i.e. object newly appeared in the tracking region at the current processing time k but not detected yet) is acquired. Hence, by adding the state distribution of the new and undetected object acquired by the first tracking processing unit 131 to an existing and undetected object acquired by the second tracking processing unit 132, a state distribution of an undetected object at the current processing time k is detected.

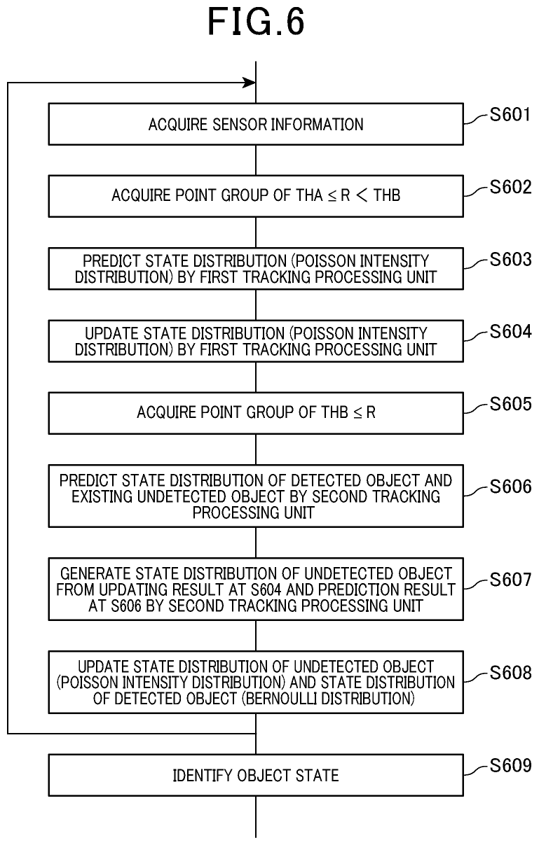

The flowchart shown in FIG. 6 shows an outline of an object tracking and a specific process at the current processing time k. The processes at respective steps shown in the flow chart are executed by the CPU 5 of the control unit 3. In FIG. 6, S is abbreviation of step and R indicates a signal intensity of the reception signal.

At step S601, the CPU 5 acquires sensor information, that is, an object detection signal from the object sensor 2.

At step S602, the CPU 5 acquires, based on the object detection signal acquired at step S601, the first positional information using the first threshold THA and the second threshold THB. In other words, the CPU 5 converts the reception intensity peak larger than or equal to the first threshold THA and less than the second threshold THB to be a point group. The process at step S602 corresponds to an operation of the first acquiring unit 111 in the positional information acquiring unit 11.

At step S603, the CPU 5 predicts a state distribution of an object at the current processing time k from the state distribution estimated by the first tracking processing unit 131 at the previous processing time k−1. The state distribution of the object to be predicted at step S603 is Poisson intensity distribution. The process at step S603 corresponds to an operation of the first tracking processing unit 131 of the object tracking unit 13 (i.e. first predicting unit 131A)

At step S604, the CPU 5 updates the state distribution of an object at the current processing time k using point group information corresponding to the reception intensity peak which is larger or equal to the first threshold THA and less than the second threshold THB. The updated state distribution acquired at step S604 is Poisson intensity distribution. Thus, a state distribution of a new and undetected object is acquired. The process at step S604 corresponds to an operation of the first tracking processing unit 131 (i.e. first updating unit 131B) of the object tracking unit 13.

At step S605, the CPU 5 acquires, based on the object detection signal acquired at step S601, the second positional information using the second threshold THB. That is, the CPU 5 converts the reception intensity peak larger than or equal to the second threshold THB to be a point group. The process at step S605 corresponds to an operation of the second acquiring unit 112 of the positional information acquiring unit 11.

At step S606, the CPU 5 predicts, based on the state distribution of undetected and detected objects which are estimated at the previous processing time k−1 by the second tracking processing unit 132, a state distribution of a detected object and an existing and undetected object at the current processing time k. The process at step S606 corresponds to an operation of the second tracking processing unit 132 (i.e. second predicting unit 132A) of the object tracking unit 13.

At step S607, the CPU 5 adds the state distribution of new and undetected object acquired at step S604 to a prediction result at step S606 for the state distribution of existing and undetected object, thereby generating the state distribution of the undetected object. The process at step S607 corresponds to an operation of the second tracking processing unit 132 (i.e. second predicting unit 132A) of the object tracking unit 13.

At step S608, the CPU 5 updates the state distribution of undetected and detected objects using point group information corresponding to the reception intensity peak which is larger or equal to the second threshold THB. The state distribution of the former one is Poisson intensity distribution and the state distribution of the latter one is Bernoulli distribution. The process at step S608 corresponds to an operation of the second tracking processing unit 132 (i.e. second updating unit 132B) of the object tracking unit 13.

The CPU 5 repeats execution of processing at steps S601 to S608 and identifies, at step S609, a state of the object at the current processing time k based on the state distribution (i.e. Bernoulli distribution) of an object detected at step S608. The process at step S609 corresponds to an operation of the state identification unit 15.

In the case where the first region is larger than or equal to the first threshold THA and the second region is larger than or equal to the second threshold THB, the functional block configuration corresponds to FIG. 5. In this case, a process of difference extracting is added to the flowchart shown in FIG. 6.

### Embodiment Related to Erroneous Detection Probability

Hereinafter, additional configuration in order to improve the tracking performance in the case where the object tracking unit 13, that is, at least one of the first tracking processing unit 131 and the second tracking processing unit 132 utilizes RFS tracking as the tracking method. The additional configuration may be applied to the above-described first to fifth embodiments.

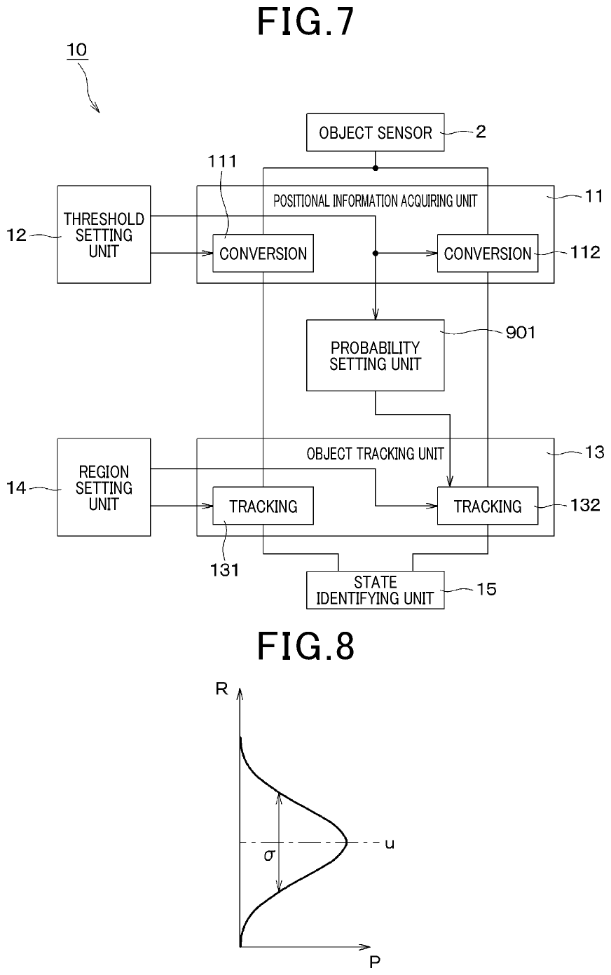

As one of setting parameters in the random finite set theory, an erroneous detection probability is present. The erroneous detection probability is also referred to as clutter rate. In the case where a set erroneous detection probability and an actual erroneous detection probability are the same, erroneous tracking or untracking of the object can be most effectively suppressed. In this respect, as shown in FIG. 7 and the like, the object recognition apparatus 10 further includes a probability setting unit 901. The probability setting unit 901 is configured to set the erroneous detection probability as a setting parameter of the object tracking unit 13.

### Sixth Embodiment

With reference to FIGS. 7 and 8, a configuration and an operation of an object recognition apparatus 10 according to the sixth embodiment having a configuration for appropriately setting the erroneous detection probability will be described.

One of causes influencing an erroneous detection probability is a threshold of the reception signal level. For example, it is assumed that main cause of generating clutter is thermal noise inside the sensor, and the thermal noise shows Gaussian distribution. In the Gausian distribution shown in FIG. 8, the vertical axis R indicates a signal intensity, the horizonal axis P indicates the probability, u indicates an average value, that is, noise floor, and σ shows a standard deviation.

When setting the threshold to be a value apart from the noise floor by σ (i.e. u+σ), erroneous detection due to clutter occurs with 40% probability. Further, when setting the threshold to be a value apart from the noise floor by 3σ (i.e. u+3σ), erroneous detection due to clutter occurs with 0.1% probability. Thus, erroneous detection probability can be set depending on the threshold value.

For this reason, according to the present embodiment, as shown in FIG. 7, the probability setting unit 901 is configured to set the erroneous detection probability depending on the threshold value. In other words, for example, the probability setting unit 901 sets the erroneous detection probability such that the erroneous detection probability is set to be smaller as the threshold value is farther away from the noise floor. FIG. 7 shows a configuration example when the second tracking processing unit 132 utilizes the RFS tracking method. In this case, the probability setting unit 901 sets the erroneous detection probability depending on the second threshold THB. A relationship between the second threshold THB and the erroneous detection probability is optimized with computer simulation, applicable testing and the like, and stored in advance into the ROM 6 and the non-volatile memory 8.

### Seventh Embodiment

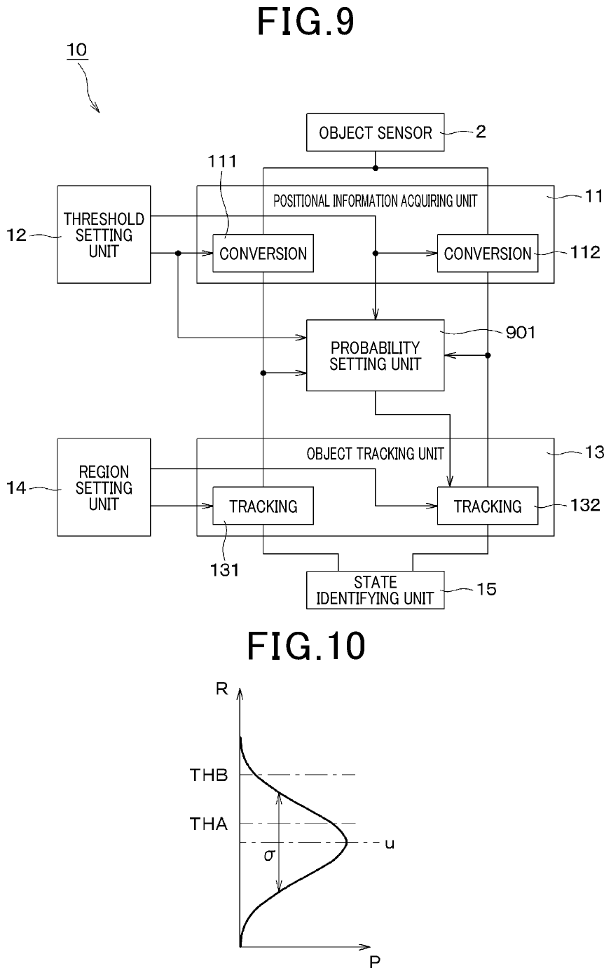

With reference to FIGS. 9 and 10, a configuration and an operation of an object recognition apparatus 10 according to the seventh embodiment will be described. According to the present embodiment, the above-described sixth embodiment is partially modified. Specifically, as shown in FIG. 9, the probability setting unit 901 is configured to set the erroneous detection probability depending on the threshold.

Note that noise floor varies depending on the environment or varies over time. Hence, when estimating the erroneous detection probability from the threshold, an error possibly occurs. On the other hand, for an object sensor 2 mounted on a vehicle sold on the market, since there is no chance to sense already-known environment, it is difficult to estimate the erroneous detection probability from observation information.

According to the above-described first embodiment and the like, the sensor information acquired by the object sensor 2, that is, object detection signal is converted to the point group information using a plurality of thresholds (first threshold THA and second threshold THB according to the above-described specific examples). Each threshold is already known. Therefore, assuming that the noise level is in accordance with Gaussian distribution as shown in FIG. 10, noise floor is appropriately estimated from a difference between acquired observation information (i.e. the number of point groups). As a result, erroneous detection probability can be acquired.

Specifically, for example, it is assumed that the first observation information is a point group composed of 1100 points and the second observation information is a point group composed of 100 points and the standard deviation of noise is not changed. In this case, the noise floor as an average value of the noise level distribution can be estimated based on a difference between the first observation information and the second observation information (i.e. 1000 points) and a difference between thresholds (i.e. difference between the first threshold THA and the second threshold THB shown in FIG. 10).

In this respect, as shown in FIGS. 9 and 10, the probability setting unit 901 sets an erroneous detection probability based on the first threshold THA, the second threshold THB, the number of pieces of observation information and the number of pieces of second observation information. Specifically, as described above, when setting the threshold value to be apart from the noise floor by σ (i.e. u+σ), erroneous detection occurs due to clutter with approximately 40% probability. In contrast, when setting the threshold value to be apart from the noise floor by 3σ (i.e. u+3σ), erroneous detection occurs due to clutter with approximately 0.1% probability. Hence, the probability setting unit 901 sets the erroneous detection probability such that the erroneous detection probability is set to be smaller as the threshold value is farther away from the noise floor. As long as the average value and the standard deviation σ of the noise level are accurately estimated based on the point group information, that is, the observation information, erroneous detection probability corresponding to respective threshold values can be accurately estimated. In other words, optimal erroneous detection probability can be estimated in accordance with a relationship between the threshold and the number of observation points.

Note that the present embodiment is applicable to a case where three or more thresholds are present. That is, the average value and the standard deviation σ of the noise level can be accurately estimated based on the three or more thresholds and the point group information acquired by converting them.

### Eighth Embodiment

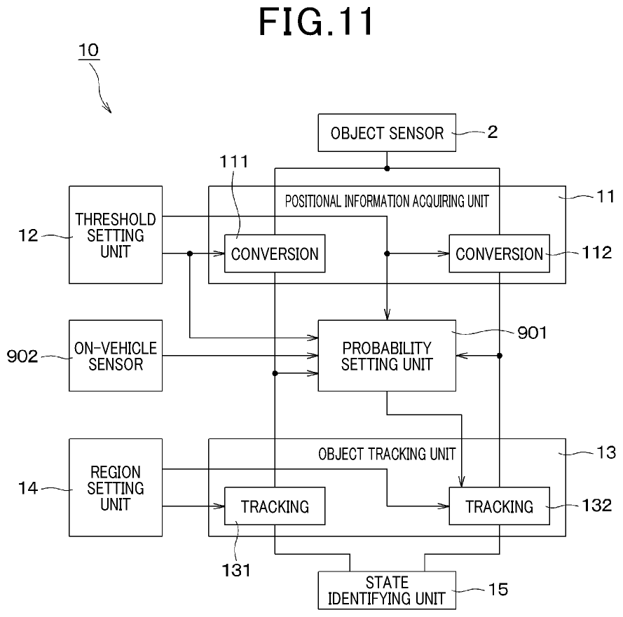

With reference to FIG. 11, a configuration and operation of an object recognition apparatus 10 according to the eighth embodiment will be described. The eighth embodiment is an embodiment in which a part of the second embodiment is modified. In other words, as shown in FIG. 11, the probability setting unit 901 is configured to set the erroneous detection probability based on the first threshold THA, the second threshold THB, the number of pieces of first observation information and the number of pieces of second observation information.

As described above, clutter may occur due to not only thermal noise in the sensor but also external disturbances caused by external factors such as rain, sunshine and dirt. Hence, the detection information of the on-vehicle sensor 902 that detects rain, sunshine, dirt and the like may be effectively utilized in order to correct such an external disturbance. For this reason, the probability setting unit 901 sets the erroneous detection probability based on a travel environment of the own vehicle acquired by the on-vehicle sensor 902. For example, the probability setting unit 901 sets the erroneous detection probability such that the larger an amount of raindrops detected by a rain sensor as the on-vehicle sensor 902, the higher the erroneous detection probability is. For example, the probability setting unit 901 sets the erroneous detection probability such that the lower the illuminance outside the vehicle cabin of the own vehicle, the higher the erroneous detection probability is set. Alternatively, the probability setting unit 901 sets the erroneous detection probability such that the larger an amount of external noise occurring due to the travel environment, the higher the erroneous detection probability is set. Thus, appropriate erroneous detection probability can be set.

### OTHER EMBODIMENTS

The present disclosure is not limited to the above-described embodiments. Hence, the above-described embodiments can be appropriately modified. Hereinafter, typical modification examples will be described. In the description for the modification examples, configurations different from those in the above-described embodiments will mainly be described. Also, the same reference numbers are applied to portions having mutually the same or equivalent configuration between the above-described embodiments and the modification examples. Therefore, in the following description of the modification example, the same explanation as that of the above-described embodiments will be applied to the constituents having the same reference numbers as those in the above-described embodiments.

The present disclosure is not limited to the specific configurations shown in the above-described embodiments. For example, the own vehicle to which the present disclosure is applied may not be a four-wheel vehicle. Specifically, the own vehicle may be three-wheel vehicles or six-wheel or eight-wheel vehicles such as a cargo truck. The type of own vehicle may be a vehicle having an internal combustion engine, or an electric vehicle or fuel cell vehicle having no internal combustion engine, or a so-called hybrid vehicle. The shape or structure of the vehicle is not limited to a box shape, that is, substantially a rectangular shape in plan view.

The object sensor 2 is not limited to a LIDAR sensor. That is, for example, the object sensor 2 may be a millimeter wave radar apparatus that transmits/receives millimeter waves or submillimeter waves. Moreover, the object sensor 2 may be a camera that captures object existing around the vehicle. Specifically, the above-described respective embodiments, that is, the present disclosure may preferably be applied to the point group information acquired based on the image captured by the camera. In this case, the intensity of an object detection signal is pixel value or a change amount thereof. The pixel value is an illuminance value or a characteristics value in which the illuminance value is converted in some format (e.g. eight digits binary number or two digit hexadecimal number). Then, the threshold is defined as a threshold of a change amount of a pixel value for detecting feature points, that is, edge points.

According to the above-described embodiments, the control unit 3 is configured as an on-vehicle microcomputer in which the CPU 5 reads programs from the ROM 6 and the like, thereby being activated. However, the present disclosure is not limited to the above configuration. Specifically, entire control unit 3 or a part of the control unit 3 may be provided with a digital circuit configured to execute the above-described operations, for example, ASIC or FPGA. ASIC is an abbreviation of application specific integrated circuit. FPGA is an abbreviation of field programable gate array. Hence, both the on-vehicle computer part and the digital circuit part can be provided in the control unit 3.

The program according to the present disclosure allowing various operations, procedure or processes to be executed, can be downloaded or uploaded via V2X communication. V2X is an abbreviation of vehicle to X. The program may be downloaded or uploaded via terminal equipment provided in a manufacturing factory, a maintenance factory, an automobile dealer and the like. The program may be stored on a memory card, an optical disk, a magnetic disk and the like.

Thus, the above-described respective functional configurations and methods may be accomplished by a dedicated computer provided with a processor and a memory, programmed to execute one or more functions embodied by the computer program. Alternatively, the above-described respective functional configurations and methods may be accomplished by a dedicated hardware configured of one or more dedicated logic circuits.

Furthermore, the above-described respective functional configurations and methods may be accomplished by one or more dedicated processing apparatus configured of a combination of a processor and memory programmed to execute one or more function, and a hardware circuit composed of one or more logic circuits.

The computer programs may be stored, as instruction codes executed by the computer, into a computer readable non-transitory tangible recording media. That is, the above-described respective functional configurations and methods may be expressed by a computer program including procedure or processes for achieving the configurations and methods or a non-transitory tangible recording media that stores the computer program.

The present disclosure is not limited to the specific operation modes or processing modes described in the above-described embodiments. For example, ‘larger than or equal to threshold’ and ‘exceeding the threshold’ may be appropriately replaced with each other as long as no technical inconsistency is present. Similarly, ‘less than or equal to threshold’ and ‘less than the threshold’ may be appropriately replaced with each other as long as no technical inconsistency is present.

Note that similar expressions such as ‘acquire’, ‘estimate’, ‘detect’, ‘calculate’, ‘extract’, ‘generate’ and the like may be appropriately replaced as long as no technical inconsistency is present.

Further, elements constituting the above embodiments are not necessarily required except that elements are clearly specified as necessary or theoretically necessary. Even in the case where numeric values are mentioned in the above-described embodiments, such as the number of constituents, numeric values, quantity, range or the like, it is not limited to the specific values unless it is specified as necessary or theoretically limited to specific numbers. Similarly, in the case where shapes, direction, positional relationships and the like of the constituents are mentioned for the constituents in the above-described embodiments, it is not limited to the shapes, direction, and positional relationships except that they are clearly specified or theoretically limited to specific shapes, directions, positional relationships and the like.

The modification examples are not limited to the above-described examples. Further, a plurality of modification examples may be combined with each other. Furthermore, all or a part of the above-described embodiments and all or a part of modification examples may be combined with each other.

### CONCLUSION

The present disclosure has been achieved in light of the above-described circumstances. The present disclosure provides an on-vehicle object recognition apparatus capable of achieving both of a large recognition region and high anti-clutter characteristics.

An object recognition apparatus is mounted on a vehicle and configured to recognize an object existing in the vicinity of the vehicle.

According to one aspect of the present disclosure, the object recognition apparatus includes: a positional information acquiring unit configured to acquire, when a reception intensity peak of reflection waves contained in an object detection signal exceeds a threshold, positional information corresponding to the reception intensity peak, the object detection signal being generated by an object sensor mounted to the vehicle, the object sensor emitting probing waves as electromagnetic waves and receiving reflection waves of the probing waves which are reflected at the object; an object tracking unit that executes, based on the positional information acquired by the positional information acquiring unit, a tracking process of the object; and a state identifying unit that identifies a state of the object based on a result of the tracking process executed by the object tracking unit.

The positional information acquiring unit includes: a first acquiring unit that acquires, when the reception intensity peak exceeds a first threshold as the threshold, first observation information as the positional information corresponding to the reception intensity peak; a second acquiring unit that acquires, when the reception intensity peak exceeds a second threshold as the threshold different from the first threshold, second observation information as the positional information corresponding to the reception intensity peak.

The object tracking unit includes: a first tracking processing unit that executes the tracking process based on the first observation information; and a second tracking processing unit that executes the tracking process based on the second observation information. Either one of the first tracking processing unit or the second tracking processing unit has anti-clutter characteristics higher than that of the other one; and the state identifying unit identifies the state of the object based on a result of the tracking process executed by the first tracking processing unit and the second tracking processing unit.

What is claimed is:

1. An object recognition apparatus mounted on a vehicle, configured to recognize an object existing in the vicinity of the own vehicle, the object recognition apparatus comprising:
a positional information acquiring unit configured to acquire, when a reception intensity peak of reflection waves contained in an object detection signal exceeds a threshold, positional information corresponding to the reception intensity peak, the object detection signal being generated by an object sensor mounted on the vehicle, the object sensor emitting probing waves as electromagnetic waves and receiving reflection waves of the probing waves which are reflected at the object;
an object tracking unit that executes, based on the positional information acquired by the positional information acquiring unit, a tracking process of the object; and
a state identifying unit that identifies a state of the object based on a result of the tracking process executed by the object tracking unit,
wherein
the positional information acquiring unit comprises:
a first acquiring unit that acquires, when the reception intensity peak exceeds a first threshold as the threshold, a first observation information as the positional information corresponding to the reception intensity peak;
a second acquiring unit that acquires, when the reception intensity peak exceeds a second threshold as the threshold different from the first threshold, a second observation information as the positional information corresponding to the reception intensity peak;
the object tracking unit comprises:
a first tracking processing unit that executes the tracking process based on the first observation information; and
a second tracking processing unit that executes the tracking process based on the second observation information,
either one of the first tracking processing unit or the second tracking processing unit has anti-clutter characteristics higher than that of the other one; and
the state identifying unit identifies the state of the object based on a result of the tracking process executed by the first tracking processing unit and the second tracking processing unit.

2. The object recognition apparatus according to claim 1,
wherein
the first threshold is lower than the second threshold;
the first tracking processing unit has anti-clutter characteristics higher than that of the second tracking processing unit.

3. The object recognition apparatus according to claim 2,
wherein
the first tracking processing unit executes the tracking process based on the first observation information that satisfies a condition in which the positional information indicates that it is in a first region;
the second tracking processing unit executes the tracking process based on the second observation information that satisfies a condition in which the positional information indicates that it is in a second region; and
the second region includes a nearer distance region than the first region.

4. The object recognition apparatus according to claim 1,
wherein
the first tracking processing unit and/or the second tracking processing unit executes the tracking process based on random finite set theory.

5. The object recognition apparatus according to claim 4 further comprising a probability setting unit that sets an erroneous detection probability as a setting parameter in the random finite theory depending on the threshold.

6. The object recognition apparatus according to claim 5,
wherein
the probability setting unit sets the erroneous detection probability based on the first threshold, the second threshold, the number of pieces of first observation information and the number of pieces of second observation information.

7. The object recognition apparatus according to claim 6,
wherein
the probability setting unit sets the erroneous detection probability such that the erroneous detection probability is set to be smaller as the threshold value is farther away from the noise floor.

8. The object recognition apparatus according to claim 5,
wherein
the probability setting unit sets the erroneous detection probability based on a travel environment of the vehicle acquired by an on-vehicle sensor.

9. The object recognition apparatus according to claim 8,
wherein
the probability setting unit sets the erroneous detection probability such that the larger external noise occurring due to the travel environment, the higher erroneous detection probability is set.

10. The object recognition apparatus according to claim 1,
wherein
the second tracking processing unit executes the tracking process based on a result of the tracking process executed by the first tracking processing unit.

11. The object recognition apparatus according to claim 10,
wherein
the second tracking processing unit includes a difference extracting unit that extracts a difference between a result of the tracking process executed by the first tacking processing unit and a result of the tracking process executed by the second tracking processing unit; and
the second tracking processing unit executes the tracking process based on the difference extracted by the difference extracting unit.

12. The object recognition apparatus according to claim 10,
the first tracking processing unit and the second tacking processing unit are configured using a state estimation filter in accordance with random finite set theory; and
a state distribution included in a result of the tracking process outputted to the second tracking processing unit from the first tracking processing unit is the same type as a state distribution of an undetected object predicted by the second tracking processing unit.

13. The object recognition apparatus according to claim 12,
the first tracking processing unit is configured using a first filter which is the state estimation filter that propagates Poisson intensity distribution; and
the second tracking processing unit is configured using a second filter which is the state estimation filter that treats Poisson intensity distribution to be a state distribution of an undetected object.

14. An object recognition apparatus mounted on a vehicle, configured to recognize an object existing in the vicinity of the own vehicle, the object recognition apparatus comprising:
a positional information acquiring unit configured to acquire positional information when an intensity of an object detection signal acquired from an object sensor exceeds a predetermined threshold;
an object tracking unit that executes, based on the positional information acquired by the positional information acquiring unit, a tracking process of the object; and
a state identifying unit that identifies a state of the object based on a result of the tracking process executed by the object tracking unit,
wherein
the positional information acquiring unit comprises:
a first acquiring unit that acquires, when the object detection signal exceeds a first threshold as the threshold, a first observation information as the positional information corresponding to the object detection signal;
a second acquiring unit that acquires, when the object detection signal exceeds a second threshold as the threshold different from the first threshold, a second observation information as the positional information corresponding to object detection signal;
the object tracking unit comprises:
a first tracking processing unit that executes the tracking process based on the first observation information; and
a second tracking processing unit that executes the tracking process based on the second observation information,
either one of the first tracking processing unit or the second tracking processing unit has anti-clutter characteristics higher than that of the other one; and
the state identifying unit identifies the state of the object based on a result of the tracking process executed by the first tracking processing unit and the second tracking processing unit.
